(19) United States
(12) Patent Application Publication
(10) Pub. No.: US 2006/0068877 A1
(43) Pub. Date: Mar. 30, 2006

(54) Marking lottery card and method for constructing database using the same

(76) Inventor: Geon-Yong Jeon, Seoul (KR)

Correspondence Address: FARJAMI & FARJAMI LLP, 26522 LA ALAMEDA AVENUE, SUITE 360, MISSION VIEJO, CA, 92691, US

(21) Appl. No.: 10/512,951

(22) PCT Filed: Jun. 27, 2002
(86) PCT No.: PCT/KR02/01230

§ 371 Date: Jul. 15, 2005

(30) Foreign Application Priority Data
May 9, 2002 (KR) 2002/25581

(51) Int. Cl. A63F 13/00

(52) U.S. Cl. 463/17

(57) ABSTRACT

Disclosed are a marketing lottery card and a method for constructing database using the marketing lottery card. The marketing lottery card is made of a transparent film or a punched paper in a form of multiple divided spaces, and comprises numbers, marks, characters, or figures, which are printed on each space. The winning or losing status of the marketing lottery card is verified by overlapping the marketing lottery card on a selected one mode from numbers, marks, characters, or figures, which are displayed on-line mass media. The marketing lottery card offers a customer several chances to receive a free gift and to enjoy a game of chance, thereby stimulating customer' interest, and maximizing advertising and promotion effects. Further, the method for constructing database using the marketing lottery card captures the attention of the customers to a free gift-offering site, thereby maximizing advertising and promotion effects and innovatively creating profitability.

### TECHNICAL FIELD

The present invention relates to a marketing lottery card and a method for constructing database using the marketing lottery card, and more particularly to a marketing lottery card providing a new profit model and a method for constructing database using the marketing lottery card, thereby stimulating customer' interest, improving advertising and promotion effects, and innovatively creating profitability.

### BACKGROUND ART

Recently, as the number of users of various wireless communication networks including the Internet has increased tremendously, commercial activity through electronic commerce (EC) and purchases made using cyber cash have also increased. In order to keep up with these trends, on-line companies make a continuous effort to open sites on the Internet in order to capture the attention of Internet customers and put forth all their energy to create various marketing methods in order to advertise articles for sale.

Among the various marketing methods, a method of capturing the attention of customers by offering a free gift has been popularly and widely used. This method is carried out via lotteries, quizzes, surveys, games, and so forth.

However, all the conventional marketing methods are already generalized, thereby not meeting company's expectations and lowering the profits generated by the marketing activity. Accordingly, in order to overcome the aforementioned problem, an innovative profit model, which further stimulates customer' interest, has been demanded.

### DISCLOSURE OF THE INVENTION

Therefore, the present invention has been made in view of the above problems, and it is an object of the present invention to provide a marketing lottery card, in which the winning or losing status of the marketing lottery card is first verified by peeling off a scratch film from the marketing lottery card, and then is secondarily verified by overlapping the marketing lottery card on a confirmation table provided on-line, thereby offering a customer several chances to receive a free gift and to enjoy a game of chance, stimulating a customer's interest, and maximizing advertising and promotion effects.

It is another object of the present invention to provide a method for constructing database using the aforementioned marketing lottery card, which captures the attention of the customers to a free gift-offering site, thereby maximizing advertising and promotion effects and innovatively creating profitability.

In accordance with one aspect of the present invention, the above and other objects can be accomplished by the provision of a marketing lottery card made of a transparent film in a form of multiple divided spaces, and comprising numbers, marks, characters, or figures, which are printed on each space, wherein the winning or losing status of the marketing lottery card is verified by overlapping the marketing lottery card on a confirmation table provided on-line.

Preferably, the multiple divided spaces of the marketing lottery card may be entirely or selectively coated with a scratch film. Thereby, the winning or losing status of the marketing lottery card is verified in two steps, i.e., first by peeling off a scratch film from the marketing lottery card, and secondarily by overlapping the marketing lottery card on the confirmation table provided on-line.

Herein, the confirmation table may be set up so that numbers, marks, characters, or figures presented on the confirmation table are rotationally changed, a customer selects one mode among the rotationally changed numbers, marks, characters, or figures by clicking a stop button so as to coincide with the mode of the customer's marketing lottery card. Then, the winning or losing status of the marketing lottery card is determined by whether the printed numbers, marks, characters, or figures of the marketing lottery card are equal to the selected numbers, marks, characters, or figures of the confirmation table.

In accordance with another aspect of the present invention, there is provided a method for constructing database using a marketing lottery card, comprising the steps of: connecting a customer obtaining the marketing lottery card distributed off-line to a free gift-offering site via the Internet and selecting a free gift-offering event; identifying whether the customer is a member of the free gift-offering site and inviting the customer to join the site unless the customer is a member of the site; displaying a pop-up window of the free gift-offering event, the pop-up window comprising a confirmation table and an identification number input area; inputting an identification number of the customer's marketing lottery card on the identification number input area; displaying the confirmation table of the pop-up window so that numbers, marks, characters, or figures presented on the confirmation table are rotationally changed; selecting one mode from the rotationally changed numbers, marks, characters, or figures by clicking a stop icon by a customer; verifying the winning or losing status of the customer's marketing lottery card by overlapping the customer's marketing lottery card on the confirmation table displayed on the pop-up window; and displaying the contents of the free gift provided to the customer on the window and simultaneously transmitting the contents to the customer in real-time through an e-mail, after finally verifying the winning or losing status of the customer's marketing lottery card.

Preferably, the method for constructing database using a marketing lottery card may further comprise the steps of asking whether the customer wants to receive one more chances to participate in a lottery for receiving a free gift, in case that the customer's marketing lottery card is not a winning card and requesting the customer, who wants to receive one more chance to participate in the lottery for getting the free gift, to respond to a designated marketing survey or to watch an advertisement for a designated time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing an embodiment of a marketing lottery card and a pop-up window for verifying the winning or losing status of the marketing lottery card in accordance with the present invention;

FIGS. 2a through 2h are schematic views showing other embodiments of a marketing lottery card in accordance with the present invention, respectively; and

FIG. 3 is a flow chart illustrating a method for constructing database using a marketing lottery card in accordance with the present invention.

### BEST MODE FOR CARRYING OUT THE INVENTION

Now, preferred embodiments of the present invention will be described in detail with reference to the accompanying drawings. The following preferred embodiments have been made only for a better understanding of the present invention. Therefore, the present invention does not limited to these preferred embodiments, and various modifications, additions, and substitutions to these preferred embodiments are possible, without departing from the scope and spirit of the invention as disclosed in the accompanying claims.

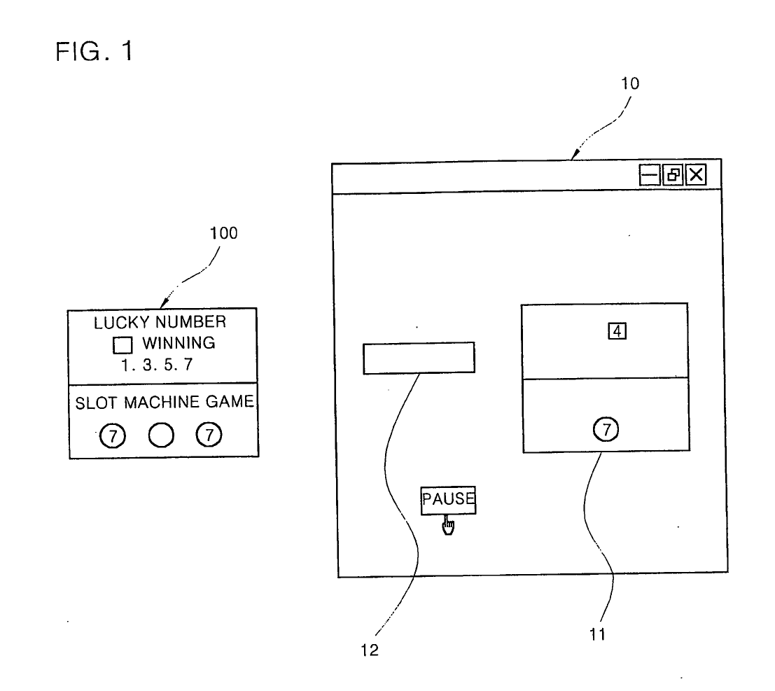

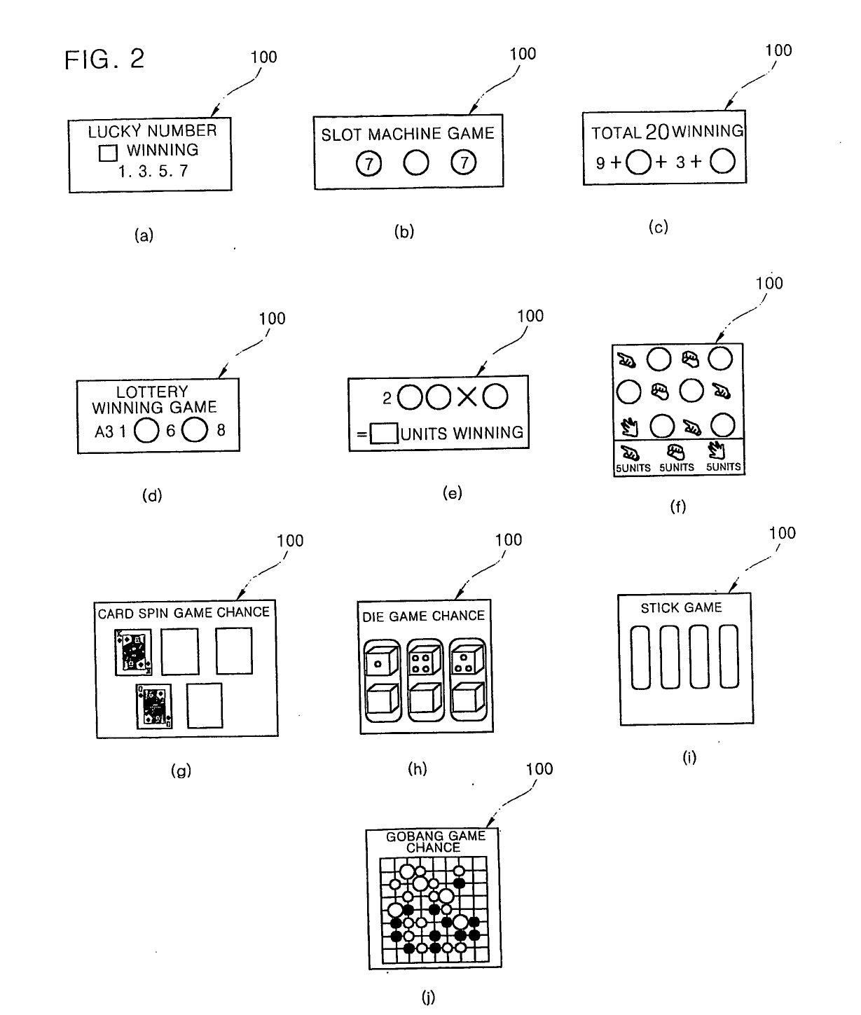

FIG. 1 is a schematic view showing an embodiment of a marketing lottery card and a pop-up window for verifying the winning or losing status of the marketing lottery card in accordance with the present invention. FIGS. 2a through 2h are schematic views showing other embodiments of a marketing lottery card in accordance with the present invention, respectively.

As shown in FIG. 1, the marketing lottery card (100) of the present invention comprises a transparent base film in a form of at least one divided space. A number, a mark, a character, or a figure is printed on each space of the transparent base film. Several randomly selected spaces of the marketing lottery card (100) are blank. The winning or losing status of the customer's marketing lottery card (100) can be verified by overlapping the marketing lottery card (100) on a confirmation table (11) provided on-line. That is, the winning or losing status of the marketing lottery card (100) can be verified by overlapping blank spaces of the marketing lottery card (100) on numbers, marks, characters, or figures presented on the confirmation table (11) of a pop-up window (10). That is, the confirmation table (11) may be provided by personal computers and various wireless mobile communication equipments such as cellular phones, personal digital assistants (PDAs), or pocket PCs.

Preferably, the confirmation table (11) of the pop-up window (10) is set up so that the numbers, the marks, the characters, or the figures presented on the confirmation table (11) are rotationally changed. A customer selects one mode among the rotationally changed numbers, marks, characters, or figures presented on the confirmation table (11) so as to coincide with the mode of the customer's marketing lottery card (100). Therefore, the winning or losing status of the marketing lottery card (100) is verified by overlapping the transparent blank spaces of the marketing lottery card (100) on the selected mode of the numbers, the marks, the characters, or the figures of the confirmation table (11).

Further, the marketing lottery card (100) of the present invention may comprise a scratch film, which is coated on the surfaces of the multiple divided spaces with the printed number, marks, characters, figures, or gift symbols. Thereby, the winning or losing status of the customer's marketing lottery card (100) is first verified by peeling off this scratch film, and then is secondarily verified by overlapping the marketing lottery card (100) on the confirmation table (11) of the pop-up window (10) provided on-line. In this embodiment of the present invention, at the second step, the winning or losing status of the customer's marketing lottery card (100) is determined by whether the numbers, the marks, the characters, or the figures printed on the customer's marketing lottery card (100) are equal to a lucky number, mark, character, or figure shown by overlapping the marketing lottery card (100) on the confirmation table (11) of the pop-up window (10). Herein, preferably, the lucky number of the marketing lottery card (100) may be coated with the scratch film, thereby verifying the winning or losing status of the customer's marketing lottery card (100) in two ways.

Herein, as shown in FIG. 2(a), the winning or losing status of the marketing lottery card (100) is determined by whether the numbers, the marks, the characters, or the figures printed on the customer's marketing lottery card (100) are equal to a lucky number, mark, character, or figure shown by overlapping the marketing lottery card (100) on the confirmation table (11) of the pop-up window (10) provided via various mass media including the Internet. In this case, preferably, the lucky number may be coated with the scratch film. Therefore, the winning or losing status of the customer's marketing lottery card (100) is first verified by peeling off this scratch film from the marketing lottery card (100), and then the winning or losing status of the marketing lottery card (100) is secondarily verified by overlapping the first-verified marketing lottery card (100) on the confirmation table (11) of the pop-up window (10) provided by the Internet, etc.

As shown in FIG. 2(b), the winning or losing status of the marketing lottery card (100) may be determined by whether numbers, marks, characters, or figures printed on the multiple divided spaces of the marketing lottery card (100) are equal to a number, a mark, a character, a figure shown via the transparent blank space of the marketing lottery card (100) by overlapping the marketing lottery card (100) on the confirmation table (11) of the pop-up window (10) provided via various mass media including the Internet. Preferably, this type of the marketing lottery card (100) may be distributed in large quantities to customers, thereby offering the customers several chances to enjoy the lottery game.

As shown in FIG. 2(c), the winning or losing status of the marketing lottery card (100) may be determined by whether the actual total sum found by adding numbers according to mathematical signs printed on the multiple divided spaces of the marketing lottery card (100) and numbers shown via transparent blank spaces of the marketing lottery card (100) by overlapping the marketing lottery card (100) on the confirmation table (11) of the pop-up window (10) provided via various mass media including the Internet is equal to the winning the total sum printed on the marketing lottery card (100). If the actual total sum is equal to the printed winning total sum, a valuable free gift is provided to the customer. Further, if the actual sum is not equal to the printed winning total sum, many inexpensive free gifts are prepared and a number of the inexpensive free gifts equal to the number of the actual total sum may be provided to the customer, thereby maximizing advertising effect. Particularly, this type of the marketing lottery card (100) may be used to promote new products of a company.

As shown in FIG. 2(d), the winning or losing status of the marketing lottery card (100) may be determined by whether a complete number achieved by combining numbers printed on the multiple divided spaces of the marketing lottery card (100) and numbers shown via transparent blank spaces of the marketing lottery card (100) by overlapping the marketing lottery card (100) on the confirmation table (11) of the pop-up window (10) provided via various mass media including the Internet is equal to a specific winning number, i.e., a randomly selected winning number. Preferably, a specific winning number is randomly selected in advance, and the selected winning number is displayed on the pop-up window (10) or printed on the marketing lottery card (100). However, a specific winning number may be selected on the spot in overlapping the marketing lottery card (100) on the confirmation table (11) of the pop-up window (10). Alternatively, a specific winning number may be selected after overlapping the marketing lottery card (100) on the confirmation table (11) of the pop-up window (10).

Further, as shown in FIG. 2(e), a number of free gifts equal to the total sum of numbers printed on the multiple divided spaces of the marketing lottery card (100) and numbers shown via transparent blank spaces of the marketing lottery card (100) by overlapping the marketing lottery card (100) on the confirmation table (11) of the pop-up window (10) provided via various mass media including the Internet may be provided to the customer. This type of the marketing lottery card (100) functions to provide inexpensive free gifts in a number equal to the number of the total sum to the customer, thereby promoting new products of a company.

As shown in FIG. 2(f), the winning or losing status of the marketing lottery card (100) may be determined by whether the actual total sum of figures printed on the multiple divided spaces of the marketing lottery card (100) and figures shown via transparent blank spaces of the marketing lottery card (100) by overlapping the marketing lottery card (100) on the confirmation table (11) of the pop-up window (10) provided via various mass media including the Internet is equal to the winning total sum printed on the marketing lottery card (100). This type of the marketing lottery card (100) may stimulate children's minds, thereby being used for special events such as an event for congratulating new term the lower graded children, thus improving the image of a company and maximizing advertising effects.

As shown in FIG. 2(g), the winning or losing status of the marketing lottery card (100) may be determined by whether playing cards printed on the multiple divided spaces of the marketing lottery card (100) and playing cards shown via transparent blank spaces of the marketing lottery card (100) by overlapping the marketing lottery card (100) on the confirmation table (11) of the pop-up window (10) provided via various mass media including the Internet are equal or combined according to rules of a certain card game. Herein, the customer is graded by the result and can receive a free gift corresponding to the grade. This type of the marketing lottery card (100) may stimulate adults' interest, thereby increasing their enjoyment. Herein, Western cards may be replaced with Korean playing cards or mah-jongg cards.

As shown in FIG. 2(h), the winning or losing status of the marketing lottery card (100) may be determined by whether dots of dice printed on the multiple divided spaces of the marketing lottery card (100) are equal to dots of dice shown via transparent blank spaces of the marketing lottery card (100) by overlapping the marketing lottery card (100) on the confirmation table (11) of the pop-up window (10) provided via various mass media including the Internet. Preferably, this type of the marketing lottery card (100) may also stimulate children's minds, thereby being used for special events such as an event for congratulating new term the lower graded children, thus improving the image of a company and maximizing advertising effects. Particularly, the customer may be graded by the number of dice printed on the marketing lottery card (100) equal to corresponding dice on the confirmation table (11) of the pop-up window (10), i.e., the case that two corresponding dice are equal, the case that all the corresponding dice are equal, and the case that some of corresponding dice are equal, and receive a free gift corresponding to the grade.

As shown in FIG. 2(i), the winning or losing status of the marketing lottery card (100) may be determined by whether sticks being used in playing Korean traditional game of yut printed on the multiple divided spaces of the marketing lottery card (100) and sticks being used in playing yut shown via transparent blank spaces of the marketing lottery card (100) by overlapping the marketing lottery card (100) on the confirmation table (11) of the pop-up window (10) provided via various mass media including the Internet are applicable to a yut game rule. Preferably, this type of the marketing lottery card (100) may be used as an event in festival days such as the Lunar New Year's Day or the Harvest Festival by the lunar calendar, thereby improving the image of a company and maximizing advertising effects.

As shown in FIG. 2(j), the winning or losing status of the marketing lottery card (100) may be determined by whether Paduk stones printed on the multiple divided spaces of the marketing lottery card (100) and Paduk stones shown via transparent blank spaces of the marketing lottery card (100) by overlapping the marketing lottery card (100) on the confirmation table (11) of the pop-up window (10) provided via various mass media including the Internet are places in a row. For example, this type of the marketing lottery card (100) may be provided in commemoration of winning a national Paduk game, thus improving the image of a company and maximizing advertising effects. Herein, Paduk may be replaced with Chess.

As shown in FIGS. 2(a) to 2(j), the above-described various embodiments of the marketing lottery cards (100) may be combined and used in a single lottery card. The combined type of the marketing lottery card (100) may offer the customers several chances to enjoy different types of lottery games.

Preferably, the size of the aforementioned marketing lottery card 100 of the present invention is controlled so as to match with the confirmation table (11) of the pop-up window (10) according to conditions of systems connected to the Internet, thereby easily verifying the winning or losing status of the marketing lottery card (100).

Hereinafter, an on-line marketing method using the aforementioned marketing lottery card (100) of the present invention is described in detail.

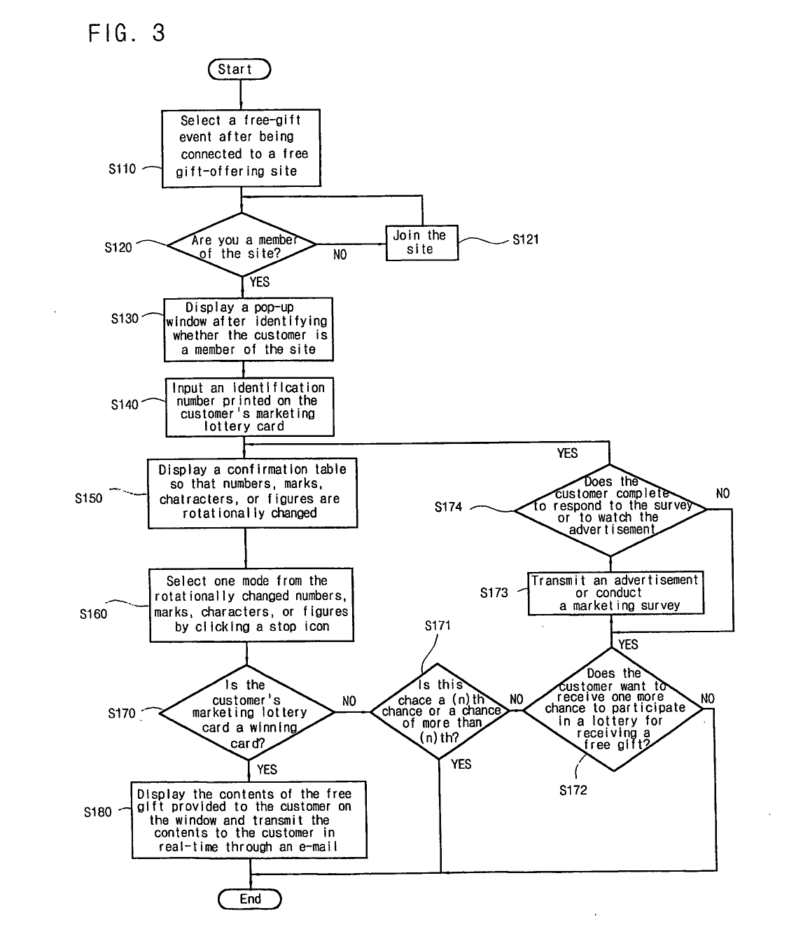

FIG. 3 is a flow chart illustrating a method for constructing database using the marketing lottery card (100) in accordance with the present invention.

As shown in FIG. 3, the method for constructing database using the marketing lottery card (100) of the present invention can be applied to all communication systems which connect customers to a free gift-offering site via the Internet. The free gift-offering site displays a window, and verifies, stores, and changes various data through the database (D/B). Herein, the communication system refers to a personal computer or wireless mobile communication equipment such as a cellular phone, a personal digital assistant (PDA), or a pocket PC. The winning or losing status of the customer's marketing lottery card (100) can be verified via these communication systems.

As shown in FIGS. 1 and 2, the marketing lottery card (100) is distributed to the public off-line, and a customer obtaining the marketing lottery card (100) is connected to a free gift-offering site via the Internet (S110). Herein, the marketing lottery card (100) may be distributed to the customers by various routes such as a free distribution, a distribution together with sold goods, an e-mail distribution and so forth.

After being connected to the free gift-offering site, the customer selects a free gift-offering event. Then, the free gift-offering site identifies whether the customer is a member of this site or not. Unless the customer is a member of the site, the customer is invited to join the site (S120).

After identifying the customer using the database, the pop-up window (10) of the free gift-offering event is displayed as shown in FIG. 1 (S130). The pop-up window (10) comprises the confirmation table (11) and an identification number input area (12).

The customer inputs an identification number of the obtained marketing lottery card (100) to the identification number input area (12) (S140). Herein, the free gift-offering site compares the inputted identification number of the customer's marketing lottery card (100) to the corresponding contents stored by the database, thereby verifying the authenticity of the customer's marketing lottery card (100).

The confirmation table (11) of the pop-up window (10) is set up so that numbers, marks, characters, or figures presented on the confirmation table (11) are rotationally changed (S150).

Herein, according to a mode of the customer's marketing lottery card (100), the customer selects one mode from the numbers, the marks, the characters, or the figures, which are being changed, by clicking a stop icon shown in the pop-up window (10) (S160). The winning or losing status of the marketing lottery card (100) is verified by the aforementioned overlapping of the marketing lottery card (100) with the confirmation table (11). Therefore, the detailed description of the overlapping principle of the marketing lottery card (100) with the confirmation table (11) is omitted.

Then, the customer overlaps his/her marketing lottery card (100) on the confirmation table (11) comprising the selected numbers, marks, characters, or figures, thereby verifying the winning or losing status of the customer's marketing lottery card (100) (S170). Herein, after verifying the winning or losing status of the marketing lottery card (100) (S170), the free gift-offering site displays a result of the winning or losing status of the marketing lottery card (100) on the pop-up window (10) using the database and requests the customer to confirm this result.

In case the customer's marketing lottery card (100) is not a winning card, the free gift-offering site asks whether the customer wants to receive one more chance to participate in a lottery for receiving a free gift (S171-S172). Herein, preferably, the chances to participate in a lottery for receiving a free gift may be limited to a designated number.

The customer who wants to receive one more chance to participate in the lottery for receiving the free gift is requested to respond to a designated marketing survey or to watch an advertisement for a designated time (S173-S174).

Another confirmation table (11) is again displayed on the pop-up window (10) and provided to the customer, having provided the response to the survey or having watched the advertisement. The customer again overlaps his/her marketing lottery card (100) on the newly displayed confirmation table (11), thereby verifying the winning or losing status of the marketing lottery card (100) one more time (S150-S170).

After finally verifying the winning or losing status of the customer's marketing lottery card (100), the free gift-offering site displays the contents of the free gift which will be provided to the customer on the pop-up window (10) and simultaneously transmits the contents to the customer in real-time through an e-mail, thereby offering improving services for improving customer's satisfaction (S180). At this time, the free gift-offering site transmits the contents of advertisements as well as the contents of the free gift provided to the customer.

### INDUSTRIAL APPLICABILITY

As apparent from the above description, the present invention provides a marketing lottery card and a method for constructing database using the marketing lottery card. In accordance with the present invention, the winning or losing status of the marketing lottery card is verified by various advertisement mass media such as newsletters, magazines, and TV, thereby offering a customer several chances to receive a free gift and to enjoy a game of chance, stimulating customer' interest, and maximizing advertising and promotion effects.

Further, the present invention captures the attention of the customers via an Internet marketing method using the marketing lottery card, thereby maximizing advertising and promotion effects and innovatively creating profitability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A marketing lottery card in a form of multiple divided spaces, and the marketing lottery card comprising:
a numbers, a marks, a characters, or a figure printed in each of the multiple divided spaces;
wherein a winning or losing status of the marketing lottery card can be verified by overlapping the marketing lottery card on a confirmation table provided on-line.

2. The marketing lottery card (100) as set forth in claim 1,
wherein the confirmation table is provided by a personal computers, as a cellular phones, a personal digital assistants (PDAs), a or pocket PC such that numbers, marks, characters, or figures presented on the confirmation table are rotationally changed;
wherein a customer selects one mode among the rotationally changed numbers, marks, characters, or figures so as to coincide with a mode of the marketing lottery card; and
wherein the winning or losing status of the marketing lottery card is determined by whether the numbers, marks, characters, or figures of the marketing lottery card are equal to the selected numbers, marks, characters, or figures of the confirmation table.

3. A method for constructing a database using a marketing lottery card, said method comprising:
connecting a customer having the marketing lottery card, obtained off-line, to a free gift-offering site via the Internet and selecting a free gift-offering event;
identifying whether the customer is a member of the free gift-offering site and inviting the customer to join the site unless the customer is a member of the site;
displaying a pop-up window of the free gift-offering event, said pop-up window comprising a confirmation table and an identification number input area;
receiving an identification number of the marketing lottery card on the identification number input area;
displaying the confirmation table of the pop-up window such that numbers, marks, characters, or figures presented on the confirmation table are rotationally changed;
selecting one mode from the rotationally changed numbers, marks, characters, or figures based on a click by the customer on a stop icon being displayed, wherein a winning or losing status of the marketing lottery card can be verified by overlapping the marketing lottery card on the confirmation table displayed on the pop-up window;
asking whether the customer wants to receive one more chance to participate in a lottery for receiving a free gift, if the marketing lottery card (100) is does not have a the winning status;
requesting the customer, if the customer wants to receive one more chance to participate in the lottery for getting the free gift, to respond to a designated marketing survey or to watch an advertisement for a designated time; and
displaying contents of the free gift to the customer on the pop-up window and simultaneously transmitting the contents to the customer in real-time via an e-mail, after finally verifying the winning or losing status of the customer's marketing lottery card.

4. The marketing lottery card as set forth in claim 1, wherein the marketing lottery card is made of a transparent film.

5. The marketing lottery card as set forth in claim 1, wherein the marketing lottery card is made of a punched paper.

6. The method as set forth in claim 3, wherein the marketing lottery card is made of a transparent film.

7. The method as set forth in claim 3, wherein the marketing lottery card is made of a punched paper.
